(19) United States
(12) Patent Application Publication
(10) Pub. No.: US 2020/0058235 A1
(43) Pub. Date: Feb. 20, 2020

(54) RESCUE TRAINING DUMMY

(71) Applicant: DR FACTORY LIMITED LIABILITY COMPANY, Saga (JP)

(72) Inventor: Rumi YAMASHITA, Saga (JP)

(21) Appl. No.: 16/665,987

(22) Filed: Oct. 28, 2019

Related U.S. Application Data
(63) Continuation of application No. PCT/JP2018/009312, filed on Mar. 9, 2018.

(30) Foreign Application Priority Data
May 25, 2017 (JP) 2017-115479

(51) Int. Cl. G09B 23/32; G09B 23/34

(52) U.S. Cl. CPC G09B 23/32; G09B 23/34

(57) ABSTRACT

The outer skin of the rescue training dummy is configured by interknitting the strip members capable of being connected and released while changing the sizes of rings of the same. Thickness and length of the body part, the arms, and the legs of the dummy can be freely reproduced. With the single rescue training dummy, the rescue training dummy can be configured to have one of different figures, such as a figure of an adult, or a figure of a child. Within the internal space of the rescue training dummy, containers or the like as weight are arranged. Enclosing substances with one of different specific gravity within the containers or the like or changing the number and/or capacity of the containers or the like enables to adjust weight of the dummy Since a device generating sound or the like may be arranged within the dummy, listening information from disaster victims can be performed in the middle of training. Thus, it is possible to contribute toward carrying out training rich in various scenarios.

### CROSS-REFERENCE TO RELATED APPLICATIONS

This application is a continuation application of PCT Application No. PCT/JP2018/009312, filed on Mar. 9, 2018, which claims priority to Japanese Patent Application No. 2017-115479, filed on May 25, 2017, the entire contents of which are incorporated by reference in its entirety.

### BACKGROUND OF THE INVENTION

### 1. Field of the Invention

The present invention relates to a rescue training dummy used for training such as rescue training, relief-training or the like assuming various disasters. The training may be performed by the fire-fighting teams, the Self-Defense Forces, and the police.

### 2. Description of the Related Art

In the past, various kinds of dummies imitating human bodies have been used in the above rescue training by the fire-fighting teams or the like. Such disaster control agencies perform training for assumed various disasters, such as a fire, an earthquake, a traffic accident. In order to effectively perform various kinds of activities, such as search for victims in an atmosphere of thick smoke, conveyance while holding a body, and holding up a body with ropes, the rescue training dummy requires various elements including: strength durable for the training; reproducibility of human body; and safety.

In addition, the victims assumed in the various kinds of disasters may be adults and/or children, have various body shapes and weight (fat or slim), which have been required training methods and verification suitable for the above various conditions of the victims.

As a conventional rescue training dummy, what is shown in Reference 1 (Japanese patent application Laid-open No. 2014-137504) may be exemplified. The rescue training dummy disclosed in Reference 1 is designed very elaborately to have both of high human body reproducibility and high strength. However, manufacturing costs and prices thereof must be high. This is a serious problem.

As another conventional rescue training dummy than Reference 1, what is shown in Reference 2 (Japanese utility model registration No. 3197475) may be also exemplified. The rescue training dummy disclosed in Reference 2 is cheaper than the training dummy disclosed in Reference 1. Unfortunately, it has poor reproducibility of a human body, especially with respect to a head part, a neck part, hands, and legs. The elbow joints and the knee joints thereof can be bent in all of direction, and have postures and movements different from those of an actual human body. In this way, it must be said that usability in rescue training is low.

According to the rescue training dummies disclosed in Reference 1 and Reference 2, body shapes and weight of the assumed victims cannot be changed and are fixed. Another dummy must be prepared in a case where the disaster control agencies would like to use a dummy whose body shape and/or weight are/is different from those of the contents of training.

### LIST OF CITED REFERENCES

Reference 1: Japanese patent application Laid-open No. 2014-137504

Reference 2: Japanese utility model registration No. 3197475

### OBJECTS AND SUMMARY OF THE INVENTION

In view of the above, an object of the present invention is to provide a rescue training dummy that has human body reproducibility necessary for the rescue training, that is easily repaired when damaged, and further that has a function capable of changing a body shape and/or weight thereof in accordance with the contents of the training.

In order to accomplish the object, a first aspect of the present invention provides a rescue training dummy wherein respective part of the dummy is configured by: combining a plurality of members capable of being easily removed. This enables to change a number and/or a size of the parts so that the body shape of the dummy can be changed, and repair of the same can be easily performed when damaged.

In addition, a second aspect of the present invention provides the rescue training dummy wherein a plurality of flexible and planar members capable of being easily removed are combined in a manner such that the members are rounded so as to have internal spaces therein, and weight or the like can be installed within the internal spaces thereof.

Furthermore, a third aspect of the present invention provides the rescue training dummy wherein a plurality of pieces of the weight is arranged within the internal spaces to freely change the weight of the dummy, thereby reproducing various weight of the victims.

### EFFECT OF INVENTION

The rescue training dummy configured according to the present invention can possess variability in a body shape and weight thereof, which cannot be accomplished by any conventional rescue training dummies Only a single rescue training dummy can reproduce various body shape and weight within the range covering from child to adult sizes. In addition, the respective part of the dummy, such as any one of four limbs, can be easily released. Therefore, the dummy can respond to rescue training rich in variations in assumed various victims. For example, a case where an arm is separated from an injured victim can be reproduced. In this way, the dummy can contribute to improve ability of rescue activities of the firefighting team, or the like.

Members constituting a head part, body parts, arm parts, and leg parts can be separated and exchanged for each part. In a case where a certain part is damaged, exchanging only the damaged part itself enables to use the dummy again. Thus, repair costs can be saved, and repair period can be shortened.

The members used for the rescue training dummy may be fire hoses after service life and/or scrapped fire hoses out of service because of water leakage or the like. Collecting and using such fire hoses enables to suppress costs inexpensively. The fire hoses have various diameters and vary in thickness. The fire hoses are folded in a planar state when the water does not path there-through. In addition, the fire hoses are made of flexible material with excellent strength, such as wear resistance, weather-ability or the like. Accordingly, the fire hoses are composed of very suitable material used for members constituting the rescue training dummy.

With regard to weight for being arranged within the dummy, PET (Polyethylene terephthalate) bottles for storing commercially available beverage or the like may be used. In this case, the rescue training dummy whose costs are suppressed inexpensively can be manufactured. The PET bottles vary in thickness and have various lengths. As for PET bottles arranged for the head part, the arm parts, and the leg parts, a plurality of PET bottles having sizes suitable for an actual human body may be combined to be arranged therein. In this case, also upon repairing and/or exchanging a certain part thereof, commercially available PET bottles may be utilized.

### BRIEF EXPLANATION OF THE DRAWINGS

FIG. 1 is a whole front view showing an example of a rescue training dummy according to the present invention imitating an adult;

FIG. 2 is a disassembled perspective diagram of the same rescue training dummy;

FIG. 3 is a perspective diagram showing an example of members used for the same rescue training dummy;

FIG. 4 is a whole front view of a reconstructed rescue training dummy imitating a child;

FIG. 5 is a disassembled perspective diagram of a head part of the same rescue training dummy;

FIG. 6 is a disassembled perspective diagram showing movement of an elbow joint part and a hand of the same rescue training dummy;

FIG. 7 is a disassembled perspective diagram showing movement of an knee joint part and a leg of the same rescue training dummy; and

FIG. 8 shows an example of layout of PET bottles arranged as weight within the same rescue training dummy.

### DETAILED DESCRIPTION OF THE PREFERRED EMBODIMENTS

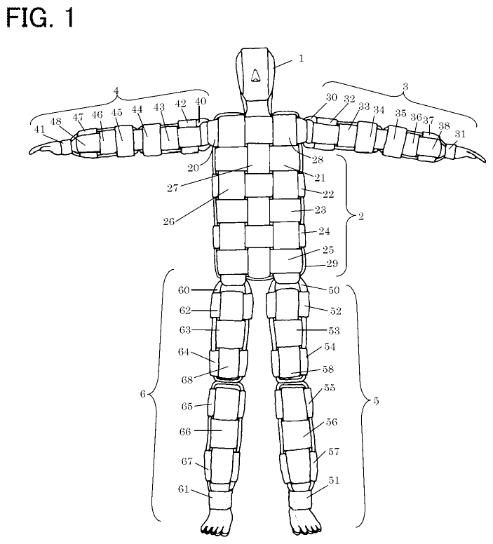

Hereinafter, referring to FIG. 1 through FIG. 8, Embodiment of the present invention will now be explained. In this Embodiment, long and flexible members (hereinafter, called as “strip members”) in a shape of a belt are used as an example of members to combine the strip members in grid shape to configure a dummy. The members and how to combine the same show merely Embodiment according to the present invention. The present invention is NEVER interpreted limiting to the Embodiment itself, and suitable design change may be carried out within the scope of the present invention. In the Embodiment, the head part, the arm parts, and the leg parts are integrated respectively, and the sizes thereof cannot be changed. Since a part or all of the members may have deformable structure by combining a plurality of members, there is no limitation with respect to the range of parts configured according to such deformation structure. In this context, suitable design change may be also carried out within the scope of the present invention.

When the scrapped fire hoses are collected and used for the members in this Embodiment, manufacturing costs can be suppressed.

Planar state material with strength and flexibility, such as fiber product, natural rubber, silicone rubber, or the like may be used instead thereof. There is no special limitation with respect to the material of the members.

Material with too high stretch-ability is not preferable. This is because, when force is applied to the members during the training or the like, the members extends too much so that the dummy loses its figure, thereby positions of weight within the internal spaces become unstable.

This Embodiment applies the structure wherein the strip members rounded to form rings are in grid shape combined in the shape of bags having internal spaces thereof. And in this structure, the sizes of the rings of the strip members can be adjusted, and the rings can be released.

In this specification, the words of “in grid shape combined in the shape of bags” mean that each of the strip members alternately pass through an inside and an outside of the dummy at positions where the strip members cross at right angles each other to be overlapped so that the strip members are three-dimensionally interknitted so as to have internal spaces thereof while forming the outer skin of the dummy.

Herein as long as the dummy does not lose the three-dimensional shape thereof, it is not needed for the strip members to alternately pass through the inside and the outside, in other words, the strip members may pass successively through only one of the inside and the outside to be interknitted.

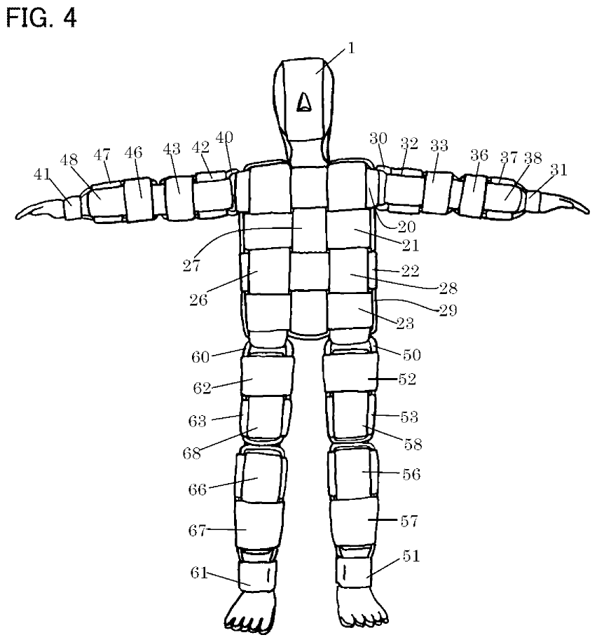

The rescue training dummy in this Embodiment can be deformed to be in either of two sizes including: the adult size shown in FIG. 1; and the child size shown in FIG. 4.

Upon changing a number, thickness, and length of strip members constituting the respective part, the rescue training dummy whose figure is capable of being changed in three or more steps can be made. For this reason, in response to various conditions (of figures, weight, or the like) necessary for training, it is possible to redesign the suitable dummy to be configured.

Furthermore, upon fixing the length of the strip members to be a constant value while not applying the structure wherein the sizes of the rings of the strip members can be adjusted, it is also possible to manufacture a rescue training dummy without the function of adjusting the figure thereof.

The rescue training dummy in this Embodiment includes: the head part; the body part; the left aim part; the right arm part; the left leg part; and the right leg part.

The parts wherein the strip members are in grid shape combined for the respective part are configured by: preparing a set of the strip members 7 shown in FIG. 3 having length and thickness suitable for the respective part; and combining the same there-with.

The strip member 7 is provided with the hook and loop fastener mounting part 8, and the hook and loop fastener mounting part 9 whose mounting range is enlarged than that of the part 8, for example. Thus, the size of the ring of the strip member 7 can be changed within the predetermined range, and ends of the same can be released to be removed.

Alternatively, as mechanism for enabling detachment and size adjustment, buckles made of metal and/or plastics may be used, and/or another structure wherein: a plurality of incisions are formed in the strip member and; nails provided with the other end are engaged therewith to be fixed may be applied.

The body part 2 is configured by: preparing a set of the strip members 7 shown in FIG. 3 having length and thickness suitable for a kind of a figure to be made; and combining the same there-with.

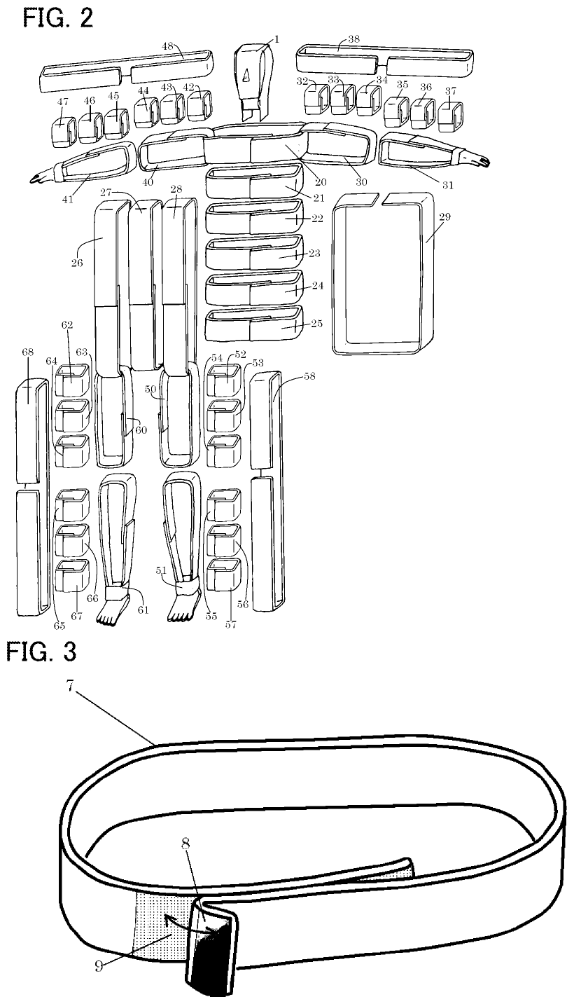

Firstly, as shown in FIG. 1 and FIG. 2, with respect to the strip member 20 for the body part, the strip member 21 for the body part, the strip member 22 for the body part, the strip member 23 for the body part, the strip member 24 for the body part, and the strip member 25 for the body part are prepared. And, the strip member 26 for the body part; the strip member 27 for the body part; and the strip member 28 for the body part are interknitted in grid shape and combined to the prepared members, respectively. After that, the strip member 29 for the body part is in grid shape interknitted on upper and lower and left and right side faces, and both ends for the strip member 29 are connected to each other to form a ring. In this way, the body part 2 in the shape of a bag including an internal space therein can be configured.

Thus, in a case where the strip member(s) constituting the body part is/are damaged, the structure wherein the plurality of strip members 7 are combined enables to easily exchange and repair the damaged strip member(s) by releasing a connecting portion of a hook and loop fastener or the like regarding the damaged strip member(s) to be released.

Releasing a certain connection portion of the strip members constituting the body part enables to access the internal space of the body part 2, thereby easily performing arrangement, exchange, or the like of the weight or the like thereof

Based on an example by means of fire hoses, how to configure the head part 1 will now be explained.

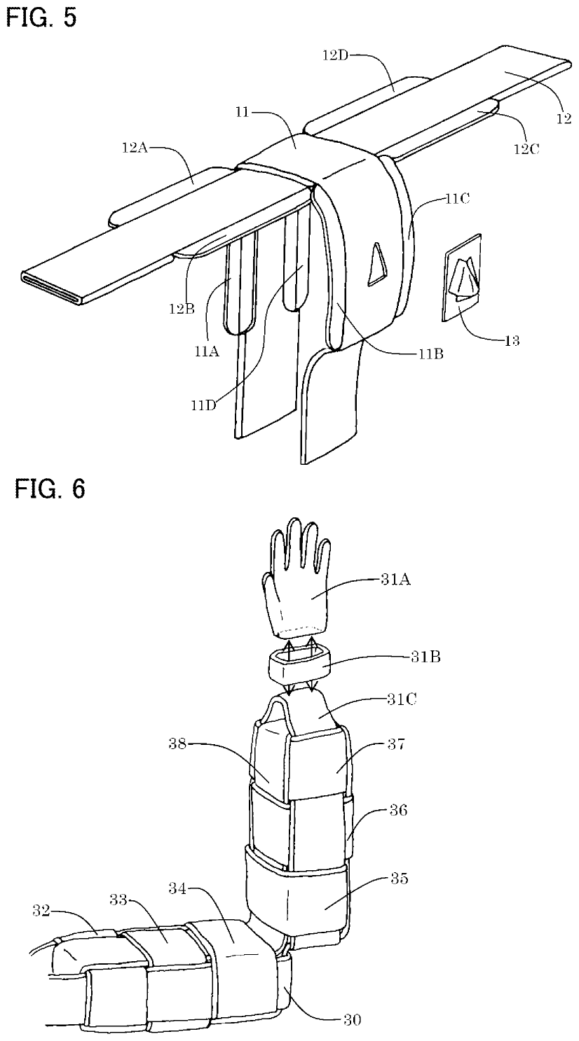

As shown in FIG. 5, two parts for the head part hose 11 and the head part hose 12 are cut to have suitable length, respectively. The respective central portions of the two parts are made to cross at right angles at a top portion of the head part.

And, the crossing portions are connected to each other by, for example sewing or the like. From a surface of the two hoses in inside of the head part, the head part connecting portion 11A, the head part connecting portion 11B, the head part connecting portion 11C, the head part connecting portion 11D, the head part connecting portion 12A, the head part connecting portion 12B, the head part connecting portion 12C, and head part connecting portion 12D are cut open to have length of the face part and length of the back of the head part, respectively.

The head part connecting portion 11A and the head part connecting portion 12A are laid on to each other to be connected by sewing or the like. The head part connecting portion 11B and the head part connecting portion 12B are laid on to each other to be connected by sewing or the like. The head part connecting portion 11C and the head part connecting portion 12C are laid on to each other to be connected by sewing or the like. The head part connecting portion 11D and the head part connecting portion 12D are laid on to each other to be connected by sewing or the like. In this way, the rounded head part can be configured.

Upon configuring a dummy of an average figure, it is necessary to configure the neck part to be thinner than the head part. Therefore, the cut open portion should not be used to be connected as the face part, but an edge portion where the head part hose 11 and the head part hose 12 contact with each other may be connected by sewing or the like.

Both ends of the head hose 11, which faces downward from the neck part, may be attached to each other (e.g. with a hook and loop fastener or the like) to be capable of being freely opened/closed immediately below the neck part. This arrangement enables to arrange weight or the like within the head part.

Both ends of the head part hose 12, which faces downward from the neck part, may be attached and connected to each other (e.g. with a hook and loop fastener or the like) to be capable of holding an upper portion of the strip members 27 constituting the body part, thereby enabling to connect the neck part to the body part 2.

In a case where a nose should be attached in order to reproduce the face part with higher fidelity, fiber product (e.g. fire hoses) may used to make the nose 13 formed imitating the same in a shape of a triangular pyramid, and a hole in a shape of a triangle may be hollowed out and cut off around the center of the front side of the head part hose 11. And then, the nose 13 may be inserted from an inner side surface of the head portion of the hole to be connected thereto by sewing or the like.

This Embodiment with respect to the left arm 3 configures the same by combining a plurality of the strip members 7 shown in FIG. 3 whose length and thickness are made to be suitable for a kind of a figure to be configured.

Herein, the strip member 31 for the left forearm has structure wherein a wrist and a hand each configured by means of other members are connected thereto.

Firstly, as shown in FIG. 2, the strip member 30 for a left upper arm passes through a side of the left arm of the strip members configured in the body part, and both ends of the strip member 30 are connected to each other to be in a state where the strip member 30 are linked thereto via a ring.

And as shown in FIG. 1 and FIG. 6, the strip member 32 for a left upper arm, the strip member 33 for the left upper arm, and the strip member 34 for the left upper arm are combined in grid shape with the strip member 30 for the left upper arm. And, the strip member 35 for a left forearm, the strip member 36 for the left forearm, and the strip member 37 for the left forearm are also combined in grid shape with the strip member 31 for the left forearm.

As shown in FIG. 6, the arm connection strip member 38 is interknitted to the whole of the left arm to connect the left forearm part and the left upper arm part via this strip member, thereby connecting both ends of the arm connection strip member 38 by means of a hook and loop fastener or the like to from a ring. The left arm 3 is configured in this way.

As shown in FIG. 6, at the elbow joint portion, the arm connection strip member 38 passes only through the front side of the body so as to make the elbow joint portion have a hinge function. Thus, a joint structure capable of being bent only in one direction can be reproduced just like an elbow joint of an actual human body.

As mentioned above, in a case where a strip member constituting the left arm is damaged, the structure wherein a plurality of strip members 7 shown in FIG. 3 are combined enables to perform easy exchange and repair by releasing a connecting portion regarding the damaged strip member to be released.

Releasing a certain connecting portion constituting the left upper arm and the left forearm one by one to be removed enables to access the internal space of the left upper arm and the left forearm, thereby easily arranging and/or exchanging weight or the like therein.

This Embodiment with respect to the right arm 4 configures the same by combining a plurality of the strip members 7 shown in FIG. 3 whose length and thickness are made to be suitable for a kind of a figure to be configured.

Herein, the strip member 41 for the right forearm has structure wherein a wrist and a hand each configured by means of other members are connected thereto.

Firstly, as shown in FIG. 2, the strip member 40 for the right upper arm passes through a side of the right arm of the strip members configured in the body part, and both ends of the strip member 20 are connected to each other to be in a state where the strip member 20 is linked thereto via a ring.

And as shown in FIG. 1 and FIG. 6 indicating an example of the left arm, the strip member 42 for the right upper ann, the strip member 43 for the right upper arm, and the strip member 44 for the right upper arm are combined in grid shape with the strip member 40 for the right upper arm. And, the strip member 45 for the right forearm, the strip member 46 for the right forearm, and the strip member 47 for the right forearm are also combined in grid shape with the strip member 41 for the right forearm.

Similar to FIG. 6 indicating the example of the left arm, the arm connection strip member 48 is interknitted to the whole of the right arm to connect the right forearm part and the right upper arm part via the strip member, thereby connecting both ends of the arm connection strip member 48 by means of a hook and loop fastener or the like to from a ring. The right arm 4 is configured in this way.

Similar to FIG. 6 indicating the example of the left ann, at the elbow joint portion, the arm connection strip member 48 passes only through the front side of the body so as to make the elbow joint portion have a hinge function. Thus, a joint structure capable of being bent only in one direction can be reproduced just like an elbow joint of an actual human body.

As mentioned above, in a case where a strip member constituting the right aiin is damaged, the structure wherein a plurality of strip members 7 shown in FIG. 3 are combined enables to perform easy exchange and repair by releasing a connecting portion (e.g. a hook and loop fastener or the like) regarding the damaged strip member to be released.

Releasing a certain connecting portion constituting the right upper arm and the right forearm one by one to be removed enables to access the internal space of the right upper arm and the right forearm, thereby easily arranging and/or exchanging weight or the like therein.

Referring to an example shown in FIG. 6 of the disassembled perspective diagram of the left hand, this Embodiment with respect to the left and right hands will now be explained.

The strip member 31 for the left forearm includes: the hand 31A imitating a left hand of a human body; the wrist 31B formed in a shape of a ring; and the forearm strip member 31C.

Firstly, the hand 31A will now be explained based on an example of configuration by means of fire hoses.

The fire hose with a suitable thickness may be cut into a shape with length of an adult palm and five fingers. After that, as shown in FIG. 6, the front faces and the rear faces of the fingers may be bonded by sewing or the like to be in a shape of a glove. Cut pieces of the hose may be filled into the inside of the glove to form a padded shape like a hand of an actual human body.

An intermediate folded portion of the forearm strip member 31C may be inserted and connected by sewing or the like from the wrist side of the hand 31A to be covered.

Furthermore, the wrist 31B configured with the fire hose or the like may be connected and covered to a hollow portion of the connecting portion between the forearm strip member 31C and the hand 31A by sewing or the like. This arrangement provides easily gripped structure just like a wrist of an actual human body.

In the above, the Embodiment with respect to the left of FIG. 6 has been explained. Regarding the right hand, only the direction of the fingers (reversely) differs there-from, and the remainder thereof may be configured as the same as the left hand.

This Embodiment with respect to the left leg 5 configures the same by combining a plurality of the strip members 7 shown in FIG. 3 whose length and thickness are made to be suitable for a kind of a figure to be configured.

Herein, the strip member 51 for the left lower leg has structure wherein an ankle and a foot each configured by means of other members are connected thereto.

Firstly, as shown in FIG. 2, the strip member 50 for a left femur passes through a lower portion of the strip members configured in the body part, and both ends of the strip member 28 are connected to each other to be in a state where the strip member 28 is linked thereto via a ring.

And as shown in FIG. 1 and FIG. 7, the strip member 52 for the left femur, the strip member 53 for the left femur, and the strip member 54 for the left femur are combined in grid shape with the strip member 50 for the left femur. And, the strip member 55 for the left lower leg, the strip member 56 for the left lower leg, and the strip member 57 for the left lower leg are also combined in grid shape with the strip member 51 for the left lower leg.

Similar to FIG. 6, the leg connection strip member 58 is interknitted to the whole of the left leg to connect the left femur and the left lower leg via this strip member, thereby connecting both ends of the leg connection strip member 58 by means of a hook and loop fastener or the like to from a ring. The left leg 5 is configured in this way.

As shown in FIG. 6, at the knee joint portion, the leg connection strip member 58 passes only through the back side of the body so as to make the leg joint portion have a hinge function. Thus, a joint structure capable of being bent only in one direction can be reproduced just like a knee joint of an actual human body.

As mentioned above, in a case where a strip member constituting the left leg is damaged, the structure wherein a plurality of strip members 7 shown in FIG. 3 are combined enables to perform easy exchange and repair by releasing a connecting portion (e.g. a hook and loop fastener or the like) regarding the damaged strip member to be released.

Releasing a certain connecting portion constituting the left femur and the left lower leg one by one to be removed enables to access the internal space of the left femur and the left lower leg, thereby easily arranging and/or exchanging weight or the like therein.

This Embodiment with respect to the right leg 6 configures the same by combining a plurality of the strip members 7 shown in FIG. 3 whose length and thickness are made to be suitable for a kind of a figure to be configured.

Herein, the strip member 61 for the right lower leg has structure wherein an ankle and a foot each configured by means of other members are connected thereto.

Firstly, as shown in FIG. 2, the strip member 60 for a right femur passes through a lower portion of the strip members configured in the body part, and both ends of the strip member 26 are connected to each other to be in a state where the strip member 26 are linked thereto via a ring.

And as shown in FIG. 1 and FIG. 7 indicating the example of the left leg, the strip member 62 for the right femur, the strip member 63 for the right femur, and the strip member 64 for the right femur are combined in grid shape with the strip member 60 for the right femur. And, the strip member 65 for the right lower leg, the strip member 66 for the right lower leg, and the strip member 67 for the right lower leg are also combined in grid shape with the strip member 61 for the right lower leg.

Similar to FIG. 7 indicating the example of the left leg, the leg connection strip member 68 is interknitted to the whole of the right leg to connect the right femur and the right lower leg via the strip member, thereby connecting both ends of the leg connection strip member 68 by means of a hook and loop fastener or the like to from a ring. The right leg 6 is configured in this way.

As shown in FIG. 6 indicating the example of the left leg, at the knee joint portion, the leg connection strip member 68 passes only through the back side of the body so as to make the leg joint portion have a hinge function. Thus, a joint structure capable of being bent only in one direction can be reproduced just like a knee joint of an actual human body.

As mentioned above, in a case where a strip member constituting the right leg is damaged, the structure wherein a plurality of strip members 7 shown in FIG. 3 are combined enables to perform easy exchange and repair by releasing a connecting portion (e. g. a hook and loop fastener or the like) regarding the damaged strip member to be released.

Releasing a certain connecting portion constituting the right femur and the right lower leg one by one to be removed enables to access the internal space of the left femur and the left lower leg, thereby easily arranging and/or exchanging weight or the like therein.

Referring to an example shown in FIG. 7 of the disassembled perspective diagram of the left and right legs, this Embodiment with respect to the left and right legs will now be explained.

The strip member 51 for the left lower leg includes: the foot 51A imitating a left foot of a human body; the ankle 51B formed in a shape of a ring; and the lower leg strip member 51C.

Firstly, the foot 51A may be configured by: cutting a fire hose into a shape with about double length of an adult foot; and folding the cut hose at the center thereof. At this time, the folded portion corresponds to a heel, and both ends laying on with each other correspond to a toe. While keeping this relationship, both sides of the foot may be connected by sewing or the like, and cut pieces of the hose may be filled into the inside of the foot to form a padded shape like a foot of an actual human body.

Furthermore, the both ends laying on with each other to correspond to the toe may be cut off to form figures of fingers, and the cut portions may be linked with sewing or the like. In this way, the foot 51A shown in FIG. 7 can be configured.

An intermediate folded portion of the lower leg strip member 51C may be connected by sewing or the like to the foot 51A, and the ankle 51B configured with the fire hose or the like may be connected and covered to a hollow portion of the connecting portion by sewing or the like. This arrangement provides the left lower leg strip member 51.

In the above, the Embodiment with respect to the left foot of FIG. 7 has been explained. Regarding the right foot, only the direction of the fingers (reversely) differs there-from, and the remainder thereof may be configured as the same as the left foot.

When a plurality of strip members are extracted from the body part, the arm part, and the leg part of the rescue training dummy shown in FIG. 1 and the other strip members are adjusted again regarding length thereof, the rescue training dummy in a child figure shown in FIG. 4 by can be configured.

For example, when the body part strip member 24 and the body part strip member 25 are released to be extracted from the body part 2 in an adult figure and with respect to the rest including: the body part strip member 20; the body part strip member 21; the body part strip member 22; the body part strip member 23; the body part strip member 26; the body part strip member 27; the body part strip member 28; and the body part strip member 29, the size of the respective ring is made smaller than before to be connected again, thereby the body part in a child figure shown in FIG. 4 can be configured.

Regarding the left arm, for example, when the left upper arm strip member 34 is extracted from the left upper arm part of the adult shown in FIG. 1 and with respect to the rest including: the left upper arm strip member 30; the left upper arm strip member 32; the left upper arm strip member 33; the left forearm strip member 31; the left forearm strip member 36; the left forearm strip member 37; and the left forearm strip member 38, the size of the respective ring is made smaller than before to be connected again, thereby the left arm in a child figure, which is shorter and thinner than the left hand of the adult, shown in FIG. 4 can be configured.

Regarding the right arm, when the paring strip members are extracted similar to the above and length of the rest are adjusted again, thereby the right arm in the child figure shown in FIG. 4 can be configured.

Similar to the arms, regarding the legs, when one strip member among the strip members interknitted perpendicularly to the direction of the legs are extracted one by one from every part of the left and right femur parts and the left and right lower leg parts and with respect to the rest of the strip members the size of the respective ring is made smaller than before to be connected again, thereby the left and right legs in the child figure, which are shorter and thinner than the legs of the adult, shown in FIG. 4 can be configured.

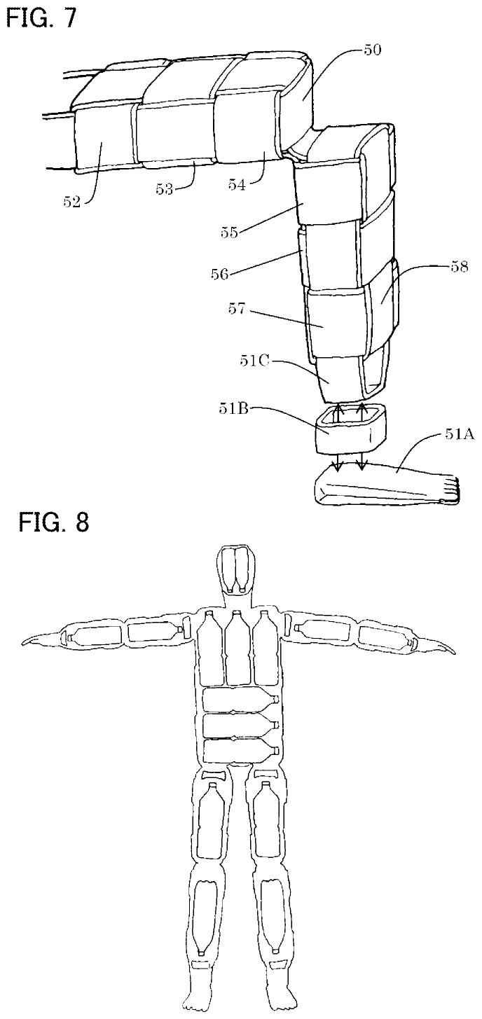

When PET bottles as an example of containers used for weight in the inside of the rescue training dummy shown in FIG. 1 imitating an adult, the dummy having been tried to be configured while using fire hoses for all of the outer skin, eighteen in total of PET bottles can be arranged therein as shown in FIG. 8.

Four PET bottles of 500 ml for the head part, six PET bottles of 2,000 ml for the body part, one PET bottle of 1,000 ml for every of the left and right forearm parts, one PET bottle of 2,000 ml for every of the left and right femur parts, and one PET bottle of 2,500 ml for every of the left and right lower leg parts are arranged, respectively. In this case, 25,000 ml of weight in total can be arranged therein.

The weight of only the outer skin part of the rescue training dummy configured imitating the adult is about 11 kg.

In a case where water whose specific gravity is 1.0 is enclosed in the inside of all of the arranged PET bottles, weight thereof is about 25 kg. Thus, about 36 kg of the rescue training dummy can be configured with the outer skin.

In another case where sand whose specific gravity is 1.7 is enclosed in the inside of all of the arranged PET bottles, weight thereof is about 42.5 kg. Thus, about 53.5 kg of the rescue training dummy can be configured with the outer skin.

In a further other case where sand whose specific gravity is 1.7 is enclosed in the inside of all of the arranged PET bottles and further where water whose specific gravity is 1.0 is further filled therein, the total specific gravity becomes about 2.0. In this case, weight thereof is about 50 kg. Thus, about 61 kg of the rescue training dummy can be configured with the outer skin.

As mentioned above, refilling the containers or the like whose enclosed material differing there-from into the dummy considering the contents of training enables to reproduce various weight of victims.

In order to adjust the weight furthermore, the rings of the strip members perpendicularly interknitted to the directions of the body, the arms and the legs may be more widely adjusted again.

Arranging PET bottles with larger capacity and/or increasing the number of the bottles to be arranged enable/enables to increase the weight. Otherwise, the weight may be reduced according to an inverse method thereof.

In this Embodiment, as the example of weight arranged within the rescue training dummy, the PET bottles for the container and sand and water for enclosed material have been used, respectively.

However, there is no limitation with respect to the containers and/or the enclosed material. Alternatively for example, within bags (e.g. water bags) and/or cylindrical containers or the like, liquid and/or powdery material other than the sand and the water may be enclosed.

Instead of enclosing material within the containers or the like, heavy load (for example, lumber, rubber and/or synthetic resins such as plastics) worked to be a size capable of being stored in the internal space of the respective part of the dummy and/or solid substance (for example, metal) may be directly arranged within the dummy.

As something to be arranged within the rescue training dummy, a communication device generating sound (for example, a transceiver, a cell phone or the like) and/or a speaker device automatically reproducing sound may be stored therein.

In this case, when the rescue training dummy is used during training, communications with the rescue training dummy imitating disaster victims are available to enable to collect information upon the disaster and to listen injured portions in the middle of the training, thereby contributing to perform the more realistic and richer in variation training.

It is preferable to apply structure wherein the communication device and/or the speaker device are/is stored at the predetermined internal position to be fixed in order to prevent the same from being damaged caused by being pressed by the internal weight and to prevent from the sound from not being heard caused by shift of the stored position. The fixed position may be any part of the rescue training dummy. However, when the fixed position is the inside of a periphery of the face portion of the head part 1, a situation as if the disaster victim actually spoke can be reproduced. There is no special limitation with respect to how to store and fix the above. For example, pocket structure wherein the above can be separated from weight within the internal space may be provided, and/or belts whose both ends are attached with a hook and loop fastener or a buckle may be used to hold the above to be fixed.

### INDUSTRIAL APPLICABILITY

The rescue training dummy according to the present invention provides the following benefits that cannot be earned by the any conventional rescue training dummies Only the single rescue training dummy can provide variability with respect to height, figure and weight. The respective part can be released to be removed from the dummy. Accordingly, disaster victims of various figure and injured conditions where one or more of four limbs are released can be reproduced. In this way, since training rich in variation can be performed, it is expected to contribute toward improving ability of rescue activities of the disaster control agency and a lifesaving rate of disaster victims.

### BRIEF DESCRIPTION OF SYMBOLS

1: Head Part
2: Body Part
3: Left Arm
4: Right Arm
5: Left Leg
6: Right Leg
7: Strip Member
8: Hook and Loop Fastener Mounting Part
9: Hook and Loop Fastener Mounting Part
11: Head Hose
11A: Head Part Connecting Portion
11B: Head Part Connecting Portion
11C: Head Part Connecting Portion
11D: Head Part Connecting Portion
12: Head Hose
12A: Head Part Connecting Portion
12B: Head Part Connecting Portion
12C: Head Part Connecting Portion
12D: Head Part Connecting Portion
13: Nose
20: Body Part Strip Member
21: Body Part Strip Member
22: Body Part Strip Member
23: Body Part Strip Member
24: Body Part Strip Member
25: Body Part Strip Member
26: Body Part Strip Member
27: Body Part Strip Member
28: Body Part Strip Member
29: Body Side Strip Member
30: Left Upper Arm Strip Member
31: Left Forearm Strip Member
31A: Hand
31B: Wrist
31C: Forearm Strip Member
32: Left Upper Arm Strip Member
33: Left Upper Arm Strip Member
34: Left Upper Arm Strip Member
35: Left Forearm Strip Member
36: Left Forearm Strip Member
37: Left Forearm Strip Member
38: Arm Connection Strip Member
40: Right Upper Arm Strip Member
41: Right Forearm Strip Member
42: Right Upper Arm Strip Member
43: Right Upper Arm Strip Member
44: Right Upper Arm Strip Member
45: Right Forearm Strip Member
46: Right Forearm Strip Member
47: Right Forearm Strip Member
48: Arm Connection Strip Member
50: Left Femur Strip Member
51: Left Lower Leg Strip Member
51A: Leg
51B: Ankle
51C: Lower Leg Strip Member
52: Left Femur Strip Member
53: Left Femur Strip Member
54: Left Femur Strip Member
55: Left Lower Leg Strip Member
56: Left Lower Leg Strip Member
57: Left Lower Leg Strip Member
58: Leg Connection Strip Member
60: Right Femur Strip Member
61: Right Lower Leg Strip Memer
62: Right Femur Strip Member
63: Right Femur Strip Member
64: Right Femur Strip Member
65: Right Lower Leg Strip Member
66: Right Lower Leg Strip Member
67: Right Lower Leg Strip Member
68: Leg Connection Strip Member

What is claimed is:

1. A rescue training dummy, including: a head part; a body part; left and right upper arm parts; left and right forearm parts; left and right femur parts; and left and right lower leg parts, wherein:
by means of a plurality of flexible strip members having both ends connected to each other in a shape of a ring, the members are interknitted three-dimensionally and perpendicularly in grid shape so as to create a space within the ring, thereby configuring the left and right upper arm parts and the left and right forearm parts, respectively;
while arranging the upper arm parts to contact with the forearm parts in a shape of a line, in direction of the line, the strip members of the both parts are interknitted via a front side of the body part by means of a common strip member, thereby connecting the upper arm parts and the forearm parts; on a surface where the upper arm parts contact with the forearm parts, the strip members connecting the both parts are interknitted via the front side of the body part, thereby reproducing an elbow joint capable of being bent only in one direction;
by means of a plurality of flexible strip members having both ends connected to each other in a shape of a ring, the members are interknitted three-dimensionally and perpendicularly in grid shape so as to create a space within the ring, thereby configuring the left and right femur parts and the left and right lower leg parts, respectively;
while arranging the femur parts to contact with the lower leg parts in a shape of a line, in direction of the line, the strip members of the both parts are interknitted via a back side of the body part by means of a common strip member, thereby connecting the femur parts and the lower leg parts, respectively; and on a surface where the femur parts contact with the lower leg parts, the strip members connecting the both parts are interknitted via the back side of the body part, thereby reproducing an knee joint capable of being bent only in one direction.

2. The rescue training dummy as defined in claim 1, wherein: by means of a plurality of flexible strip members having both ends connected to each other in a shape of a ring, the members are interknitted three-dimensionally and perpendicularly in grid shape so as to create a space within the ring, thereby configuring the body part; and
while passing the strip members configuring an end surface of the left and right femur parts as defined in claim 1 through left and right rings of a lower portion of the strip members, thereby connecting the femur parts to the body part.

3. The rescue training dummy as defined in claim 1, wherein with structure that both ends of the strip members in a shape of a ring can be released and/or sizes of the ring can be changed so that a number of the strip members and/or the size of the ring can be adjusted, thereby enabling a figure of the rescue training dummy to be adjusted.

4. The rescue training dummy as defined in claim 1, wherein weight can be arranged within an internal space of the dummy so as to be capable of adjusting weight of the dummy.
